(19) United States
(12) Patent Application Publication
(10) Pub. No.: US 2010/0280878 A1
(43) Pub. Date: Nov. 4, 2010

(54) SYSTEM AND METHOD FOR MANAGING, RECONCILING, BALANCING, AND FORECASTING FINANCIAL MEDIA IN SELF-SERVICE DEVICES

(76) Inventors: Matthew J. WILSON, Kansas City, MO (US); Gilbert H. Anderson, Overland Park, KS (US); Todd F. Shutts, Prairie Village, KS (US); Douglas Allen Dodson, Olathe, KS (US); Joel Edward Sikes, (US); Deanna Sikes, Overland Park, KS (US)

Correspondence Address: SPENCER, FANE, BRITT & BROWNE, 1000 WALNUT STREET, SUITE 1400, KANSAS CITY, MO, 64106-2140, US

(21) Appl. No.: 12/433,554

(22) Filed: Apr. 30, 2009

(51) Int. Cl. G06Q 40/00; G06Q 10/00; G06Q 30/00; G06F 15/16

(52) U.S. Cl. 705/10; 705/21; 705/30; 705/35; 709/204

(57) ABSTRACT

A system and method for managing, reconciling, balancing, and forecasting financial media in self-service devices. The system comprises self-service devices 32, a point-of-sale server 40, and a communications server 50. The self-service devices send self-service information to the point-of-sale server and the data is stored in a database 28 and verified against data received from the self-service devices. The data is presented in a graphical representation on a display to a bookkeeper in a readily understandable format, providing the bookkeeper with near real-time view into the self-service devices. When self-service device data exceed a given threshold, outbound alerts and messages are transmitted via the wide area network (WAN) 60 to the communications server 50, where they are transmitted across the internet 70 to mobile devices 90 or an e-mail mailbox 80.

### FIELD OF THE INVENTION

The present invention relates to managing, reconciling, balancing, and forecasting financial media in self-service devices. More particularly, the invention relates to computer programs that monitor and report the near real-time status of self-service devices associated with an electronic network and are capable of full integration with balancing, reconciliation and financial media forecasting software.

### BACKGROUND OF THE INVENTION

In attempts to increase efficiency and cut costs, many grocery stores and other retail and wholesale establishments that use cash registers to ring up sales have installed unmanned, substantially automated self-checkout systems. Other similar unmanned devices are often used for coin redemption, lottery ticket sales, and automated safes (collectively referred to as self-service device (“SSD”) systems or terminals). Installation of SSD systems is growing in popularity and numbers throughout retail stores and has reduced costs associated with labor for traditional cashier positions, but their use has actually increased labor, cash usage, and job complexity for store personnel that maintain the systems. Typically, a single employee will monitor a number of these SSD terminals to identify or address any problems that users may occur. Each terminal uses automated dispensing machinery, including coin canisters, for accepting and dispensing both cash and coins.

Unfortunately, these SSD systems typically contain large volumes of currency and often require daily balancing. As a result, it is difficult to monitor and maintain the cash and coins in the system to transact business for long periods of time while accounting for and balancing the money added during replenishment, the payments received from customers, the money dispensed to customers, pick-ups (the removal of excess cash for security reasons), and loans (the addition of extra cash for change-making purposes). Furthermore, while each SSD terminal may increase efficiency and cut costs by reducing the number of cashiers or other personnel, they increase the time and labor costs associated with balancing, reconciling, and monitoring the terminals.

An employee tasked with monitoring the terminals must take manual action when alerted and leave the back office to pick up cash from the terminal. The employee must then count the money by hand, and write down and key in the figures manually into the point of sale (“POS”) servers, SSDs, or financial accounting systems. This process is costly to the business, as it requires additional labor and time to transfer data from the SSDs to the POS servers, SSDs or financial accounting systems, and is also prone to clerical error.

Those skilled in the art will appreciate that such manual methods for balancing and reconciling SSD systems are very time consuming and often lead to clerical errors. Any traditional point-of-purchase terminals, such as traditional cash registers, must also be balanced and reconciled. In addition, balancing and reconciling must be carried out on a daily basis. Processes have been developed to allow stores to skip a fixed amount of days prior to balancing; however, these are also manual processes and prone to error. For large stores that have multiple SSD and other point-of-purchase terminals, the costs associated with such monitoring and reconciling are substantial.

Systems and methods that automate some aspects of monitoring have also been developed. However, these systems and methods rely on simple hardware data, such as alerts for when a given dispenser is low or empty. Such systems do not provide near real-time data from the SSDs. Thus, in order to determine all the information required, employees must constantly leave the back office to retrieve SSD and other point-of-purchase terminal data from their physical locations.

### SUMMARY OF THE INVENTION

The present invention solves the above-described problems and provides a distinct advance in the art of monitoring and reconciling self-service device systems. More particularly, the present invention provides near real-time monitoring and reporting of financial media-related and other information for self-service devices and allows operators to set thresholds and alerts for cash replenishment and pickups. The present invention allows the cash office to monitor in near real-time the level of cash and coin, down to the penny, or in the case of lottery devices, lottery tickets, in each self-service device. The present invention also provides on-screen guides for balancing, reconciliation, and forecasting purposes. This greatly reduces the time and labor needed for pick-ups, balancing, and reconciliation, significantly reduces error often attributed to manual processes, decreases wear and tear on equipment, and reduces the amount of cash necessary to have on hand.

In one embodiment, the present invention is implemented with a computer program stored on a computer-readable media for directing operation of a computer. The computer program communicates across a network with self-service devices and provides a near real-time graphical representation of the status of the self-service devices, including financial media-related information. The graphical representation presents the data in a readily understandable format, which can be quickly assimilated. In various embodiments, self-service devices are comprised of self-checkout terminals, automated safes, coin redemption machines, lottery ticket vending machines, and other similar devices. In various embodiments, the financial media-related information includes cash received, coin received, cash dispensed, coin dispensed, cash remaining in dispensers, and coin remaining in dispensers. An employee tasked with monitoring the status of such systems can be immediately updated, down to the penny, with the contents of a self-service device. The present invention receives data directly from the SSDs and is directly integrated into reconciliation software, such as Balance Innovation's VeriBalance®, described in part in U.S. Pat. No. 7,273,167, entitled “Revenue Balance Method and Computer Program,” filed Feb. 11, 2005, hereby incorporated by reference into the present application as though fully set forth herein.

Thus, the information retrieved from the SSDs can be immediately reconciled with the data from a POS server, SSD, or financial accounting system, without the need for manual processes.

During the balancing and reconciliation process, the present invention guides the operator through a step-by-step process of counting the financial media and also provides guidance on putting cash and coin back into the till so the self-service devices are being balanced at the same time. In addition, the program can be integrated with cash and coin forecasting software to track and forecast cash and coin needs for a self-service device. The present invention also allows a user to select the frequency for balancing and reconciling the self-service devices and is further operable to facilitate automated balancing, obviating the need to perform daily balancing.

The system is operable to track financial media through different functions of the system. Thus, the present invention integrates reconciliation with monitoring and reporting between all components of the system, and greatly reduces the time necessary to pinpoint errors. The system is operable to allow a user to set thresholds, whereby near real-time financial media data from the self-service devices trigger alerts when thresholds are exceeded. The system is further operable to send alerts when thresholds are exceeded for hardware devices. In one embodiment, the hardware device is a bill counting device. In another embodiment, the hardware device is a coin counting device. In yet another embodiment, the hardware device is a scale. In various embodiments, the alerts are transmitted via e-mail messages, text messages, and on-screen messages.

These and other features of the present invention are described in greater detail below in the section titled DETAILED DESCRIPTION OF THE INVENTION.

### BRIEF DESCRIPTION OF THE DRAWING FIGURES

The present invention is described herein with reference to the following drawing figures, with greater emphasis being placed on clarity rather than scale:

FIG. 1 is a network diagram that represents one embodiment of the present invention;

FIG. 2 is a detailed network diagram that represents one embodiment of the present invention;

FIG. 3. is a screen-shot of the Self-Checkout Balancing Wizard allowing the bookkeeper to select either Auto Balance or Full Balance;

FIG. 4 is a screen-shot of the bill dispenser function of the Self-Checkout Balancing Wizard;

FIG. 5 is a screen-shot of the coin dispenser function of the Self-Checkout Balancing Wizard;

FIG. 6 is a screen-shot of the coin acceptor function of the Self-Checkout Balancing Wizard;

FIG. 7 is a screen-shot of the bill acceptor function of the Self-Checkout Balancing Wizard;

FIG. 8 is a screen-shot of the Self-Checkout Balancing Wizard allowing the bookkeeper an opportunity to confirm totals;

FIG. 9 is a screen-shot of the non-cash function of the Self-Checkout Balancing Wizard;

FIG. 10 is a screen-shot of the rebuilding function for bill dispensers of the Self-Checkout Balancing Wizard;

FIG. 11 is a screen-shot of the pickups and loans function of the Self-Checkout Balancing Wizard;

FIG. 12 is a screen-shot of the coin dispensers function of the Self-Checkout Balancing Wizard; and

FIG. 13 is a screen-shot of the Lane Dispenser Change function of the Self-Checkout Balancing Wizard.

### DETAILED DESCRIPTION OF THE INVENTION

With reference to the drawing figures, a system and method is herein described, shown, and otherwise disclosed in accordance with various embodiments, including a preferred embodiment, of the present invention. Broadly, the present invention provides a system and method for managing, reconciling, balancing, and forecasting financial media in self-service devices. The present invention streamlines the task of managing self-service devices by providing store personnel with a near real-time view into the self-service devices and allows informed decisions regarding replenishment and balancing. As a result, the labor and expenses to maintain the self-service devices, the wear and tear on the equipment, and the amounts of financial media needed on hand are all significantly decreased.

As used herein, the term “near real-time” pertains to the delay introduced, by processing or network transmission, between the occurrence of an event and the transmission, display, or warning that results from the event. As used herein, the term “financial media” may include paper cash, coins, checks, credit card receipts, coupons, travelers' checks, food stamps, lottery tickets, and any other financial instruments. The term “financial media” may also include user-configurable financial instruments such as in-store coupons. The different types of financial media may also be referred to as “fields” of financial media herein. For example, the computer program of the present invention may include fields for cash, checks, and credit cards. The term “till” includes tills and any other type of drawer, holder, or enclosure that is used to hold, receive, and dispense financial media in connection with self-service devices.

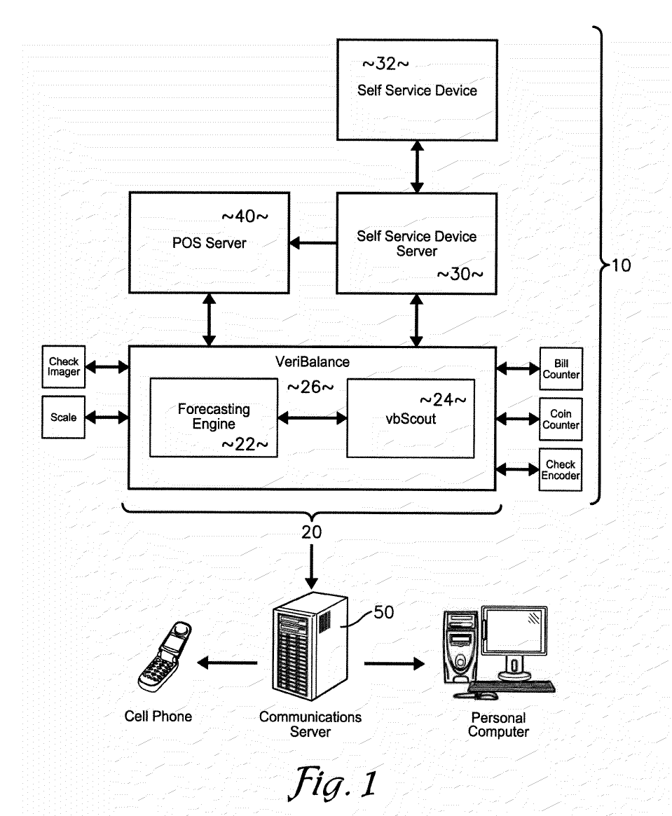

The present invention can be implemented in hardware, software, firmware, or a combination thereof. In one embodiment, the invention is implemented with a computer program that operates and manages the equipment broadly referred to by the numeral 10 in FIG. 1. The computer program 24 communicates with the equipment via an electronic network. In the present embodiment, the equipment 10 includes a computer 20, an SSD server 30, at least one self-service device 32, a POS server 40, and a communications server 50. In another embodiment, not shown, the equipment includes a computer, a POS server, and a communications server. The computer program and equipment illustrated and described herein are merely examples of a program and equipment that may be used to implement the present invention.

The computer program 24 controls operation of and/or receives inputs from the POS server 40, the communications server 50, and the forecasting software 22. The computer 20 may be any computing device. The computer includes or is coupled with conventional input devices (not shown) such as a keyboard and a computer mouse. The computer is also coupled with a computer monitor (not shown) or screen.

The POS server 40 is coupled with the computer 20 via a POS server interface. The POS server communicates with the self-service devices 32 in a store and communications server 50 provides inputs to the computer as described in more detail below. The computer may interface with any POS server such as the IBM Supermarket 1, Supermarket 5.2, Ace System, or other POS server manufacturers. Although the computer is coupled with a POS server as illustrated, the computer program functions without a direct connection to a POS server.

The computer program 24 of the present invention, also referred to as vbScout, is stored in or on computer-readable medium residing on or accessible by the computer 20 for instructing the computer and other components of the computer equipment 10 to operate as described herein. The computer program may run in DOS, Windows, or any other operating system environment and, in one embodiment, comprises an ordered listing of executable instructions for implementing logical functions in the computer and any computing devices coupled with the computer 20.

The computer program 24 can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electro-magnetic, infrared, or semiconductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

Once the computer program 24 is installed, it may be started with a command, such as “cash.exe”. The computer program then displays an icon on the desktop of the operating system software of the computer 20. The program then goes through an initialization phase where it checks software protection keys, loads required data from the computer hard drive into memory, sets the monitor display for the correct display mode, loads needed drivers for display types and fonts, and initializes the components coupled with the computer.

The computer program 24 initially displays a main menu or screen on the monitor. The main menu provides links to various self-service device functions such as wizards for balancing and rebuilding or performing pickups and loans. The main menu also provides links to sub-menus such as setup whereby an operator may configure various options and flags to their specific needs and desires.

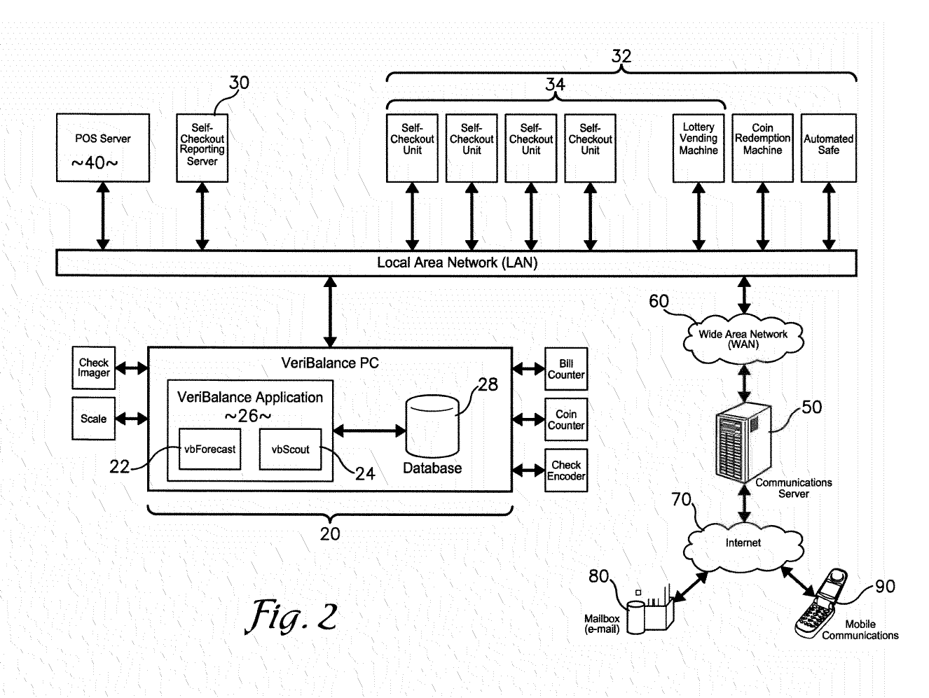

Referring to FIG. 2, in one embodiment, the POS server 40 communicates with the point-of-purchase terminals 34, the SSD terminals 32, and the computer 20. The data received by the computer from the POS server is verified against the information received from the SSDs during the reconciliation process.

In one embodiment, the self-service devices transmit self-service information to the POS server 40, which in turn transmits the information to the computer 20 for balancing and reporting purposes. In addition, the self-service devices 32 send self-service information to the POS server, which is also sent directly to the computer, in one embodiment, or to the SSD server 30, in another embodiment. If the data is sent to the SSD server, it is retrieved by the computer program 24. The data retrieved from the self-service devices is then stored in a database 28 on the computer, which is shared, in one embodiment, by balancing and reconciliation software, such as VeriBalance® 26, the computer program, and a forecasting engine, such as the one used by vbForecast 22. The data triggers alerts and provides information in the on-screen guides. During the reconciliation process, data received from the POS server is verified against data received from the self-service devices or the SSD server.

In one embodiment, a reporting server is utilized to retrieve data from the self-service devices 32. The computer program 24 communicates with the SSD server 30 to retrieve data and manage the status of these self-service devices. Data is then transmitted from the self-service devices to the computer 20 and stored for device management use by the computer program. This data is also used to present on a display the status of the self-service devices in a near real-time graphical representation, including financial media-related information. The graphical representation presents the data in a readily understandable format, which can be quickly assimilated, so the bookkeeper can determine the exact amount of each denomination in any component of a self-service device, including bill dispensers, coin dispensers, coin acceptors, and bill acceptors. The graphical representation also presents the data so the bookkeeper can readily determine if any amounts within the self-service device exceed or are close to exceeding any thresholds. In one embodiment, the data is presented in a bar graph format, with identifying threshold markings representing warning and alert levels. When the devices exceed a given threshold, outbound alerts and messages are transmitted via the wide area network (WAN) 60 to the communications server 50, where they are transmitted across the internet 70. In one embodiment, the alerts are transmitted to a mailbox 80, as an e-mail message. In another embodiment, the alerts are transmitted to a mobile device 90, as a text message. The hardware devices are connected to the computer's communication ports via universal serial bus (USB) and serial ports. These devices assist with vbScout functions such as self-service device balancing, pickups, and loans. Transactional and cash and coin level data retrieved by the vbScout interface is used by a forecasting engine to make loan and starting cash level recommendations.

In accordance with one aspect of the present invention, the computer program includes a routine or portion that permits an operator to simultaneously balance or reconcile a self-service device. From the vbScout tab, the bookkeeper right clicks on the cell under the Total column associated with the desired self-service device and then highlights and selects Balance Till. To begin the balancing process, the bookkeeper then is prompted for proper login credentials, or a bookkeeper identification (ID) number and password. Bookkeeper ID numbers are typically assigned to accounting personnel who are authorized to balance, reconcile, and manage self-service devices. The term “bookkeeper” is a user-definable aspect of the program.

After a successful login, the screen changes and a selection window appears. A selection screen may appear, allowing the bookkeeper to select the appropriate period, generally defined as a business day. The “Expected” amounts indicate the amount of each field of financial media that should be in the SSD till based on sales information from the POS server for that business day. In one embodiment, the computer program prompts the bookkeeper to enter the “Expected” amounts. In another embodiment, the “Expected” amounts for each field are received automatically from the store's POS server.

The computer program also stores and accumulates over/short amounts for each self-service device. Used in conjunction with the POS server, this accumulated total is used to compute current “Expected” amounts for each field of financial media for each self-service device. Thus, if a bookkeeper balances more than one self-service device, the “Expected” amounts will only be reflective of what is expected to be in that particular self-service device.

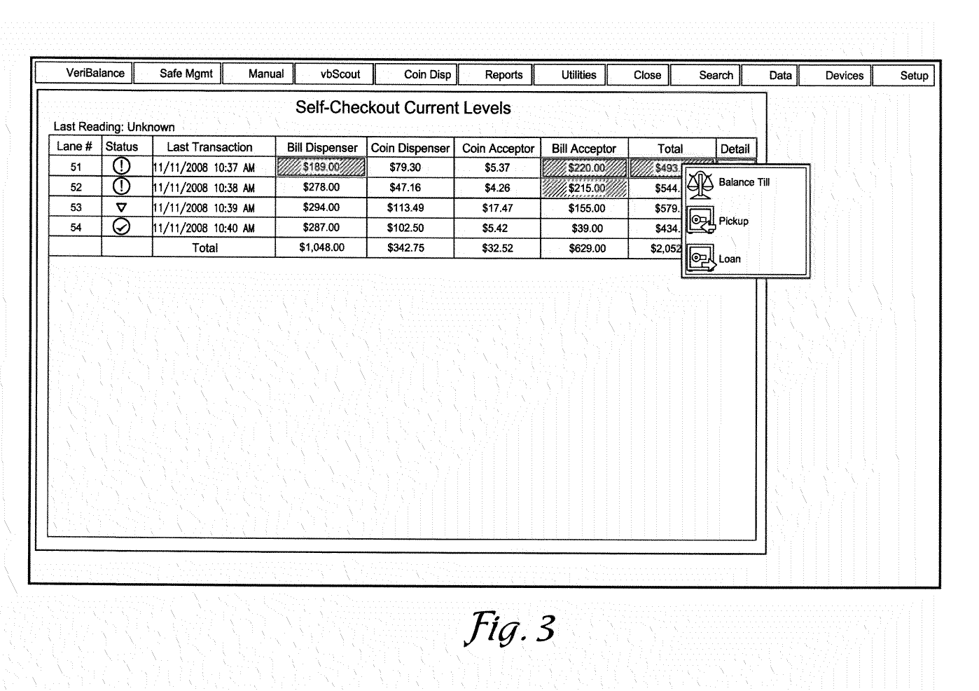

When the “Expected” amounts for the till that is to be balanced have been entered or received from the POS server, the computer program is ready to begin balancing and rebuilding the till. Referring to FIG. 3, the computer program next prompts the operator to select Auto Balance or Full Balance. Selecting Auto Balance allows the bookkeeper to move cash totals from a previous business day to the current business day automatically. Once all accounts have been balanced, the bookkeeper is returned to the vbScout screen.

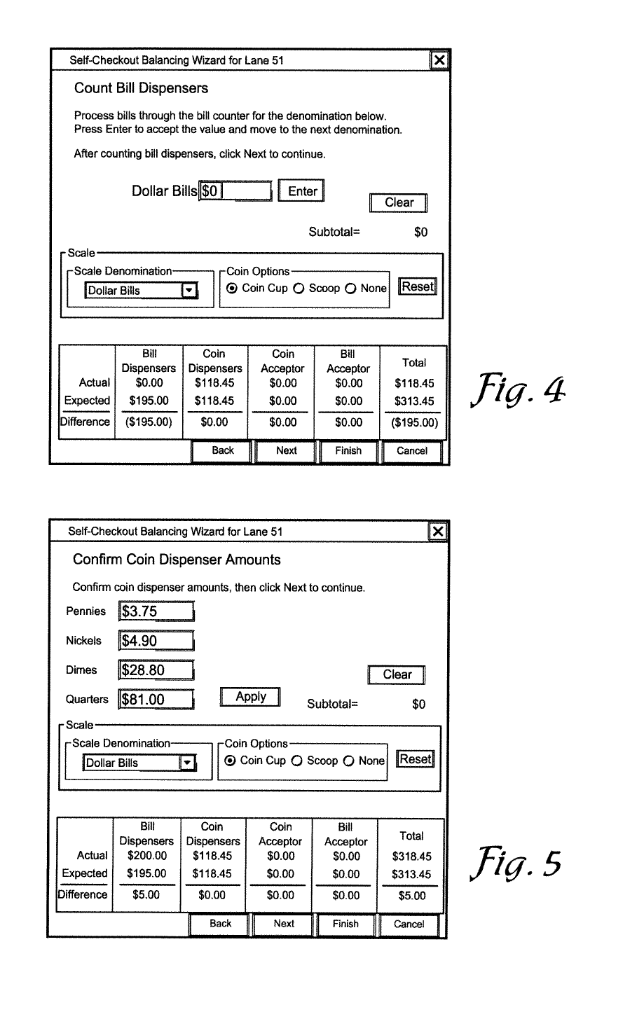

If Full Balance is selected, the bookkeeper is guided through a full balance of the till by a Self-Checkout Balancing Wizard. Referring to FIG. 4, the system first guides the bookkeeper to count the bill dispensers. This wizard prompts the bookkeeper to remove the bills and either process through a bill counter, a scale, or count and enter amounts manually. If the bill counter option is selected, the bills are processed through the bill counter and the appropriate amount is populated in the Subtotal line, the bills are then placed back into the bill dispenser. If the scale option is selected, the appropriate denomination is chosen, the bills are placed on the scale, the denomination amount is populated into the Subtotal line, the bills are placed back into the dispenser, and the next denomination is processed. If the manual process is selected the bills are counted manually, the denomination amount is entered into the field provided, and the process is repeated until all bill dispensers have been processed.

Referring to FIG. 5, the system then proceeds to guide the bookkeeper through the coin dispenser balancing process. During this process, the system automatically populates the denomination fields with the expected amounts based on data from the self-service device. The bookkeeper is provided an opportunity to accept the expected amounts and move onto the coin acceptor portion of the balancing wizard or is able to select a Clear option, allowing the bookkeeper to verify the coin dispenser contents. If the Scale option is selected, the user is able to weigh each denomination on a scale. Under Coin Options, the bookkeeper may select a Coin Cup, a Scoop, or None whereby the system weighs the coins and populates the denomination fields with the correct values. If the Coin Counter option is selected, the bookkeeper places all coins through the coin sorter and the denomination fields are populated accordingly. Finally, the bookkeeper may count the coins manually and enter the values as appropriate into the denomination fields.

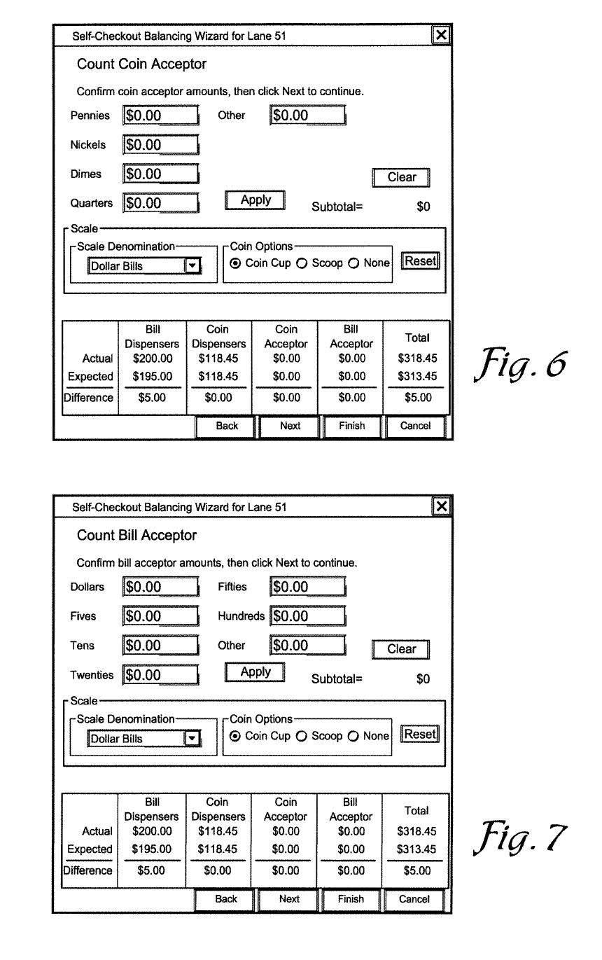

Referring to FIG. 6, the system proceeds to guide the bookkeeper through the coin acceptor balancing process. During this process, the system automatically populates the denomination fields with the expected amounts based on data from the self-service device. The bookkeeper is provided an opportunity to accept the expected amounts and move onto the bill acceptor portion of the balancing wizard or is able to select a Clear option, allowing the bookkeeper to verify the coin acceptor contents. If the Scale option is selected, the user is able to weigh each denomination on a scale. Under Coin Options, the bookkeeper may select a Coin Cup, a Scoop, or None whereby the system weighs the coins in accordance with the selected Coin Option and populates the denomination fields with the correct values. If the Coin Counter option is selected, the bookkeeper places all coins through the coin sorter and the denomination fields are populated accordingly. Finally, the bookkeeper may count the coins manually and enter the values as appropriate into the denomination fields.

Referring to FIG. 7, the system next guides the bookkeeper to count the bill acceptors. This wizard prompts the bookkeeper to remove the bills and either process through a bill counter, a scale, or count and enter amounts manually. If the bill counter option is selected, the bills are processed through a bill counter, the appropriate value is populated in the Subtotal line, and the bills are placed back into the bill dispenser. If the scale option is selected, the appropriate denomination is chosen, the bills are placed on the scale, the denomination amount is populated into the Subtotal line, the bills are placed back into the dispenser, and the next denomination is processed. If the manual process is selected the bills are counted manually, the denomination amount is entered into the field provided, and the process is repeated until all bill dispensers have been processed.

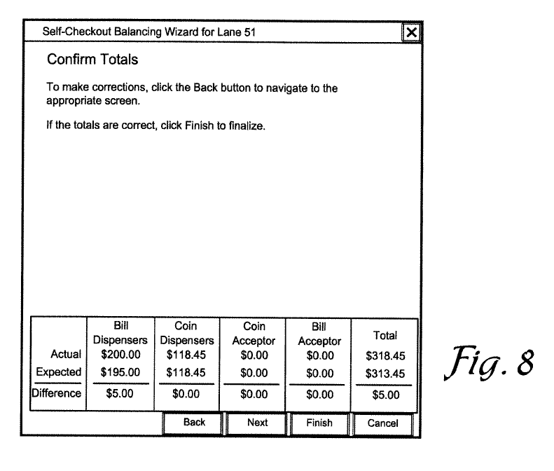

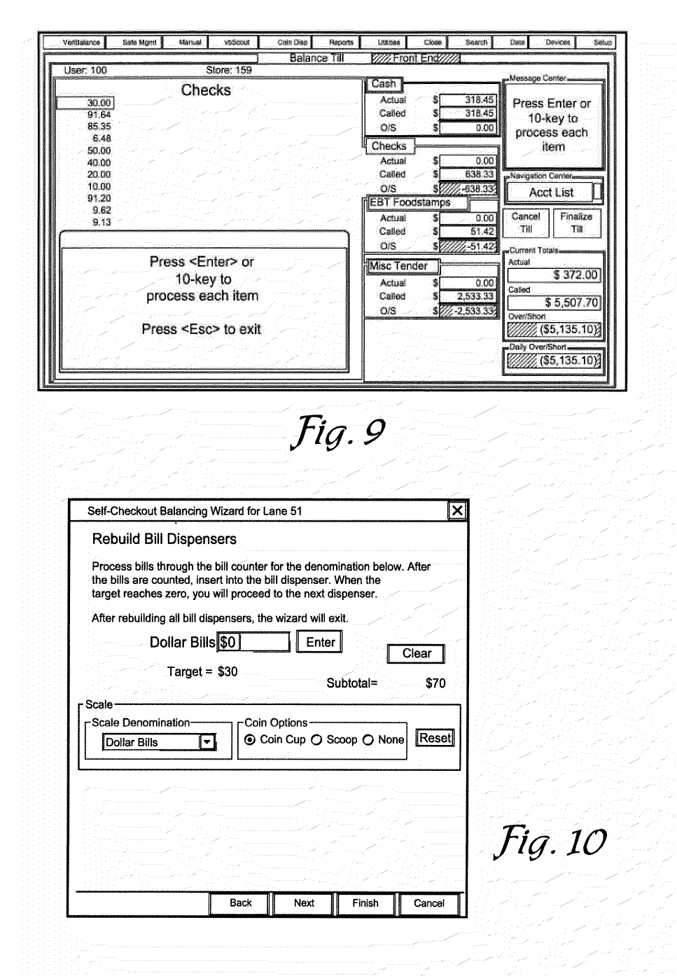

Referring to FIG. 8, the bookkeeper is given an opportunity to confirm the totals and review or recount as necessary. When the bookkeeper is satisfied and accepts the totals, the wizard closes and a Balance Till screen appears, allowing the processing of non-cash accounts. Referring to FIG. 9, a list of checks and the amounts of the checks that should be in the first cash drawer are received directly from the POS server and displayed on the screen in a checks list. In addition, an area for user comments is provided if an over/short for the self-service device exceeds a predetermined store tolerance level.

The Self-Checkout Balancing Wizard then reappears for the rebuilding portion. During the balancing process, the wizard calculates the amounts of cash and coin needed to reach the initial target amounts for a self-service device. The wizard then guides the bookkeeper through the rebuilding process. Referring to FIG. 10, the wizard begins the process by rebuilding bill dispensers. The bookkeeper may choose to use a bill counter, a scale, or count and enter amounts manually. If the bill counter option is selected, bills are retrieved from a safe and each denomination is processed through the bill counter. Once the target amount is reached, the bill counter automatically stops and excess bills are removed from the top hopper of the bill counter and returned to the safe. Counted bills are removed from the bottom hopper of the bill counter and placed in the appropriate bill dispenser. If the scale option is selected, a first denomination is placed on the scale using the shuffling method until the target amount is reached. Then all bills are removed from the scale and placed into the bill dispenser. If the number of bills exceeds the target, the system prompts the bookkeeper to place the excess back into the safe. This process is repeated for all denominations until all dispensers contain the target amount. If the manual process is selected, the bookkeeper retrieves the exact number of bills from the safe necessary to reach the target amount and enters that amount into the field provided. If excess bills are taken, the system prompts the bookkeeper to return the excess amount to the safe. This process is repeated for all denominations until all dispensers contain the target amount. Depending on the system configuration, coin dispensers may be exchanged or left alone. With the Self-Checkout Balancing Wizard completed, the system returns to the vbScout screen.

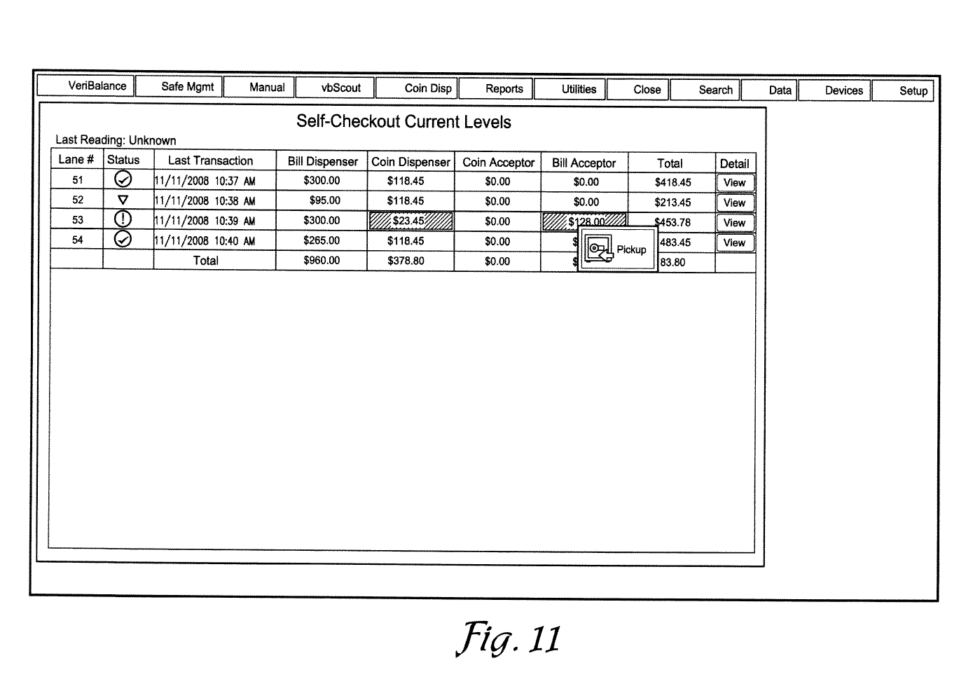

Referring to FIG. 11, when the bookkeeper determines it necessary to perform a pickup or loan, the vbScout tab is again accessed. After selecting the appropriate cell under the device column associated with the self-service device, the bookkeeper right clicks that cell and highlights the appropriate function and clicks. The bookkeeper is prompted for a bookkeeper ID and password for authentication. If the bookkeeper selected either a pickup or loan under the Total column, a selection window appears prompting the bookkeeper to select the appropriate device type (acceptor or dispenser). The pickup or loan may then be performed according to store procedures. The system returns to the vbScout screen.

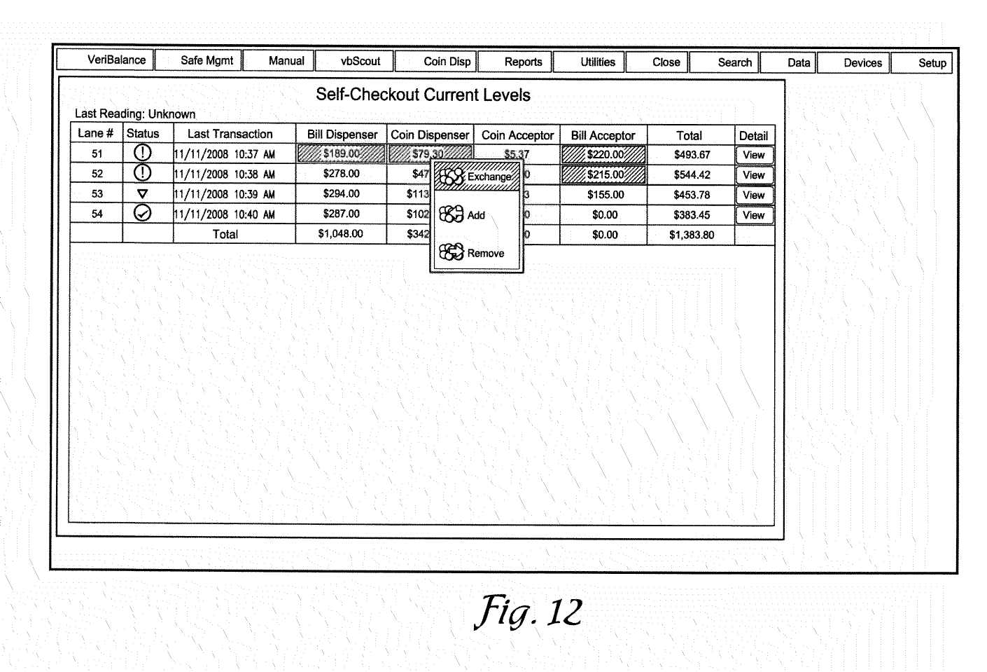

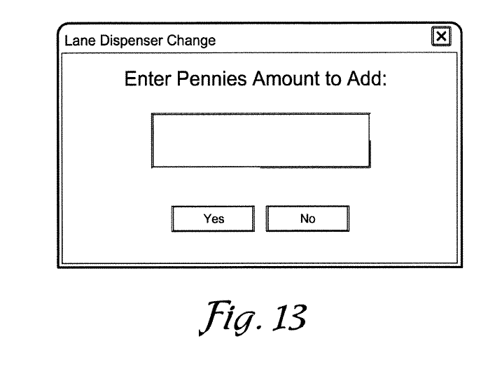

Referring to FIG. 12, if the bookkeeper determines that coin canisters need to be exchanged, the bookkeeper right clicks the Coin Dispenser cell associated with the appropriate self-service device and highlights and clicks on the Exchange function. The bookkeeper is prompted for a bookkeeper ID and password for authentication and a window appears indicating the exchange process was successful. A full canister may then be retrieved from the safe and the used canister can be removed and replaced in the self-service device with the full canister. Referring to FIG. 13, the Lane Dispenser Change window allows bookkeeper determined amounts to be added or removed as necessary.

The present invention provides numerous benefits and advantages. For example, because the computer program of the present invention automates the reconciliation and balancing of self-service devices and alerts a bookkeeper when pickups, loans are needed, bookkeepers do not have to constantly leave the back office to service the self-service devices. This essentially eliminates lost labor due to interruptions and dramatically reduces the time required to manage the self-service devices.

Although the invention has been disclosed with reference to various particular embodiments, it is understood that equivalents may be employed and substitutions made herein without departing from the scope of the invention as recited in the claims.

Having thus described the preferred embodiment of the invention, what is claimed as new and desired to be protected by Letters Patent includes the following:

1. A system for managing self-service devices comprising:
at least one self-service device operable to generate financial media-related information;
at least one network operable to transmit the financial media-related information; and
a computer program operable to retrieve and report the financial media-related information in near real-time.

2. The system of claim 1, wherein the at least one self-service device comprises self-checkout terminals.

3. The system of claim 1, wherein the at least one self-service device comprises automated safes.

4. The system of claim 1, wherein the at least one self-service device comprises coin redemption machines.

5. The system of claim 1, wherein the at least one self-service device comprises lottery ticket vending machines.

6. The system of claim 1, further comprising a condition monitor for detecting and generating alerts for the at least one self-service device for exceeding thresholds set by a user.

7. The system of claim 1, further comprising on-screen instructions operable to guide a user through counting the financial media within and balancing the at least one self-service device.

8. The system of claim 1, further comprising a point-of-sale server operable to communicate with the at least one self-service device.

9. The system of claim 1, further comprising a reconciliation system operable to reconcile the at least one self-service device.

10. The system of claim 1, further comprising a forecasting engine operable to track and forecast financial media needs for the at least one self-service device.

11. The system of claim 1, further comprising an interface operable for selecting the frequency for balancing and reconciling the at least one self-service device.

12. The system of claim 1, wherein the financial media-related information is presented on a display in near real-time.

13. The system of claim 1, further comprising hardware devices triggering the alerts.

14. The system of claim 1, further comprising the financial media-related information triggering the alerts.

15. The system of claim 1, further comprising an e-mail message transmitting the alerts.

16. The system of claim 1, further comprising a text message transmitting the alerts.

17. The system of claim 1, further comprising an on-screen message transmitting the alerts.

18. The system of claim 1, wherein the financial media-related information includes: cash received, coin received, cash dispensed, coin dispensed, cash remaining in dispensers, and coin remaining in dispensers.

19. The system of claim 1, wherein the network is operable for bi-directional communication between hardware devices and the monitoring software.

20. The system of claim 13, wherein the hardware devices comprise bill counting devices.

21. The system of claim 13, wherein the hardware devices comprise coin counting devices.

22. The system of claim 13, wherein the hardware devices comprise a scale.

23. A method for tracking financial media from self-service devices comprising the steps of:
providing near real-time graphical representation of a self-service data set of at least one self-service device;
receiving a point-of-sale data set directly from at least one point-of-sale server;
reconciling the self-service data set with the point-of-sale data set.

24. The method as set forth in claim 23, further including the step of displaying on-screen instructions to a user, wherein the instructions guide the user through counting financial media within and rebuilding the at least one self-service device.

25. The method as set forth in claim 23, wherein the at least one self-service device comprises self-checkout terminals.

26. The method as set forth in claim 23, wherein the at least one self-service device comprises automated safes.

27. The method as set forth in claim 23, wherein the at least one self-service device comprises coin redemption machines.

28. The method as set forth in claim 23, wherein the at least one self-service device comprises lottery ticket vending machines.

29. The method as set forth in claim 23, further including the step of providing recommendations for levels of financial media needed in the at least one self-service device.

30. The method as set forth in claim 23, further including the step of generating alerts for exceeding thresholds set by a user.

31. The method of claim 30, wherein the alerts are transmitted via an e-mail message.

32. The method of claim 30, wherein the alerts are transmitted via a text message.

33. The method of claim 30, wherein the alerts are transmitted via an on-screen message.

34. A computer-readable medium encoded with a computer program for facilitating monitoring of self-service devices, wherein the computer program is executable by a computing device, the computer program comprising instructions for:
retrieving a self-service data set from at least one self-service device;
providing a near real-time graphical representation of the self-service data set;
retrieving a point-of-sale data set directly from at least one point-of-sale server;
reconciling the self-service data set with the point-of-sale data set.

35. The computer-readable medium as set forth in claim 34, further comprising instructions for generating alerts for exceeding thresholds set by a user.

36. The computer-readable medium as set forth in claim 34, further comprising instructions for providing recommendations for levels of financial media needed in the at least one self-service device.

37. The computer-readable medium as set forth in claim 34, further comprising instructions for displaying on-screen instructions to a user, wherein the instructions guide the user through counting financial media within and balancing the at least one self-service device.

38. The computer-readable medium as set forth in claim 34, further comprising instructions for tracking and forecasting financial media needs for the at least one self-service device.

39. A system for reconciling self-service devices comprising:
at least one self-service device operable to generate financial media-related information;
a network for transmitting the financial media-related information; and
an on-screen reconciling guide for displaying on-screen instructions to a user, wherein the instructions guide the user through counting the financial media within and reconciling with an expected amount.

40. A system for balancing self-service devices comprising:
at least one self-service device operable to generate financial media-related information; and
an on-screen balancing guide for displaying on-screen instructions to a user, wherein the instructions guide the user through balancing the at least one self-service device.

41. A system for forecasting financial media requirements for self-service devices comprising:
at least one self-service device operable to generate financial media-related information; and
an on-screen forecasting guide for displaying on-screen instructions to a user, wherein the instructions provide the user with recommendations for levels of financial media needed in the at least one self-service device.
